(19) United States
(12) Patent Application Publication
(10) Pub. No.: US 2006/0066629 A1
(43) Pub. Date: Mar. 30, 2006

(54) System and method for color selection

(75) Inventors: Rebecca A. Norlander, Seattle, WA (US); Cyra S. Richardson, Bellevue, WA (US); Michael Stokes, Eagle, ID (US)

Correspondence Address: SHOOK, HARDY & BACON L.L.P.;(c/o MICROSOFT CORPORTATION), 2555 GRAND BOULEVARD, KANSAS CITY, MO, 64108-2613, US

(73) Assignee: Microsoft Corporation, Redmond, WA (US)

(21) Appl. No.: 10/953,189

(22) Filed: Sep. 30, 2004

(51) Int. Cl. G09G 5/02

(52) U.S. Cl. 345/594

(57) ABSTRACT

A system and method for color management are disclosed. The system may include stored color palettes and a structured color picker for selecting color choices from the color palettes. The structured color picker may include a set of colorist theory rules for facilitating selection of harmonious colors from the color palettes. A user may input an image having a preferred color combination in order to create a desirable color palette. A user interface wizard may also be provided for allowing user to select a color palette or particular colors within the color palette. The color picker may expose the harmonious colors to the user through the user interface wizard. Furthermore, the color management system enables adjustment of selected colors based on user color deficiency.

### CROSS-REFERENCE TO RELATED APPLICATIONS

None.

### STATEMENT REGARDING FEDERALLY SPONSORED RESEARCH OR DEVELOPMENT

None.

### TECHNICAL FIELD

Embodiments of the present invention relate to selection of colors in a computerized environment. In particular, embodiments of the invention relate to facilitating user selection of colors for user interface items.

### BACKGROUND OF THE INVENTION

In current computing environments, selecting colors and choosing themes remains a complex and difficult experience for users. Typically operating system designers choose a palette and select themes such as “bright”, “warm”, “high contrast”, etc. Thus, operating system designers manually create themes with color pickers that use a simple color gradient for providing visual clues for what color groups are related. From the visual clues, the operating system designers decide which colors form desirable combinations and create a limited number of themes.

If a user wants a different theme or color scheme, a long complicated process is required to assign each color to each user interface component. Often, a user may want to incorporate color selections from a pre-existing color scheme. For instance, a user may have a favorite painting or photograph and may want to incorporate selected colors from the painting or photograph into a user interface.

In contrast to current practice in the computer industry, colorists have strived to provide order to color selection for many decades. Examples of such attempts by colorists include Munsell's “Sweden's Natural Color System” and the ISCC-NBS color order system and universal color language. A recent attempt is by Shigenobu Kobayashi in his book “The Colorist”. Kobayashi provides techniques for assessing color preferences including a word image scale and complementary colors as well as relationships to geographical regions, architecture, fashion, and fine art. Existing techniques for user interface color selection do not utilize such techniques.

Furthermore, existing techniques for selecting user interface colors do not account for the portion of population that is color deficient. Almost eight percent of the human population is color deficient to some extent. Color deficient users perceive selected colors differently from the general population. Accordingly, user interface colors selected by operating system tools will not have the intended appearance for color deficient computer users.

Based on colorist theories as described above, a solution is needed for incorporating automated design principles for presenting color choices to a user and allowing user flexibility to set themes, yet guiding the user to prevent poor color choices. A solution is also needed for selecting colors to accommodate color deficient users. Furthermore, a solution is needed for incorporating an existing color combination from a painting, photograph, or other source as preferred by a user.

### BRIEF SUMMARY OF THE INVENTION

Embodiments of the present invention are directed to a system for facilitating selection of user interface colors. The system includes at least one color source including multiple selectable colors and a structured color picker for selecting color choices from the color source. The structured color picker includes a set of colorist theory rules for facilitating selection of harmonious colors from the color source.

In an additional embodiment of the invention, a system for facilitating selection of a user interface theme is provided. The system includes a set of color palettes and a user interface wizard for allowing a user to select a particular color palette. The system additionally includes a color picker for selecting harmonious colors from the particular color palette and exposing the harmonious colors to the user through the user interface wizard. The user interface wizard enables the user to construct a theme based on the harmonious colors.

In a further embodiment, a method is provided for facilitating selection of user interface colors. The method includes receiving an input image through an image input mechanism and processing the input image to replicate input image colors. The method additionally includes creating a palette based on colors of the input image.

In yet an additional embodiment, a method is provided for facilitating selection of user interface colors for a color deficient user. The method includes making a color deficiency determination based on user input, creating an inverse color appearance model to compensate for the color deficiency, and processing input colors through the inverse color appearance model prior to presentation to the user.

### BRIEF DESCRIPTION OF THE DRAWINGS

The present invention is described in detail below with reference to the attached drawings figures, wherein:

FIG. 1 is a block diagram illustrating an overview of a system in accordance with an embodiment of the invention;

FIG. 2 is a block diagram illustrating a computerized environment in which embodiments of the invention may be implemented;

FIG. 3 is a block diagram illustrating a color appearance adjustment engine in accordance with an embodiment of the invention;

FIG. 4 is a block diagram illustrating a color picker in accordance with an embodiment of the invention;

FIG. 5 is a flow chart illustrating a method for creating a palette from a source image in accordance with an embodiment of the invention; and

FIG. 6 is a flow chart illustrating a method for analyzing a source image in accordance with an embodiment of the invention.

### DETAILED DESCRIPTION OF THE INVENTION

I. System Overview

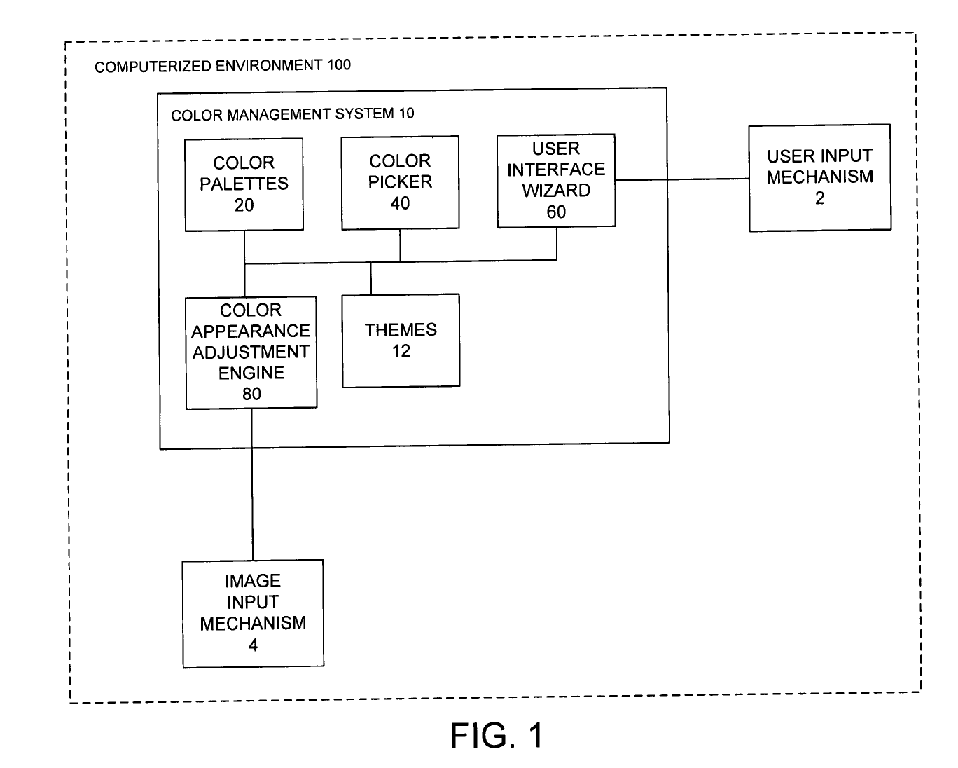

Embodiments of the invention include a method and system for facilitating color selection for a user interface. FIG. 1 illustrates a color management system 10 within a computerized environment 100. The color management system 10 may include color palettes 20, a color picker 40, a user interface wizard 60, a color appearance adjustment engine 80, and themes 12. A user input mechanism 2 and an image input mechanism 4 may facilitate user interaction with the color management system 10.

Through the user input mechanism 2, a user may interact with the user interface wizard 60 to utilize the color picker 40 for selecting color combinations. The color picker 40 extracts colors from existing color palettes 20 and creates themes 12 based on user preferences. Each of the palettes 20 includes a limited set of colors and may be provided as a distinct module in a computer operating system.

A user may input an image using the image input mechanism 4. The image may be a photograph of a scene or painting having a color combination that the user would like to replicate. The image input mechanism 4 sends the input to the color appearance adjustment engine 80. The color appearance adjustment engine 80 includes components for processing the input image and incorporating its colors into a color palette 20. Accordingly, the color appearance adjustment engine 80 creates a color palette for each image input by the image input mechanism 4. In some instances, the color appearance adjustment engine 80 may include components to transform the colors of the input image based on a user's color deficiency.

Thus, the method and system of the invention provide a technique for automatically extracting a set of colors to create a color palette from a source, such as for example a photographic image, a painting, or a database of colors. The system and method of the invention additionally provide for integration of a simple wizard to quantify the user color deficiencies and integrate the results into themes. The system and method of the invention additionally provide a structured color picker 40 to optimize the user experience and facilitate user selection of colors, themes, and palettes.

II. Exemplary Operating Environment

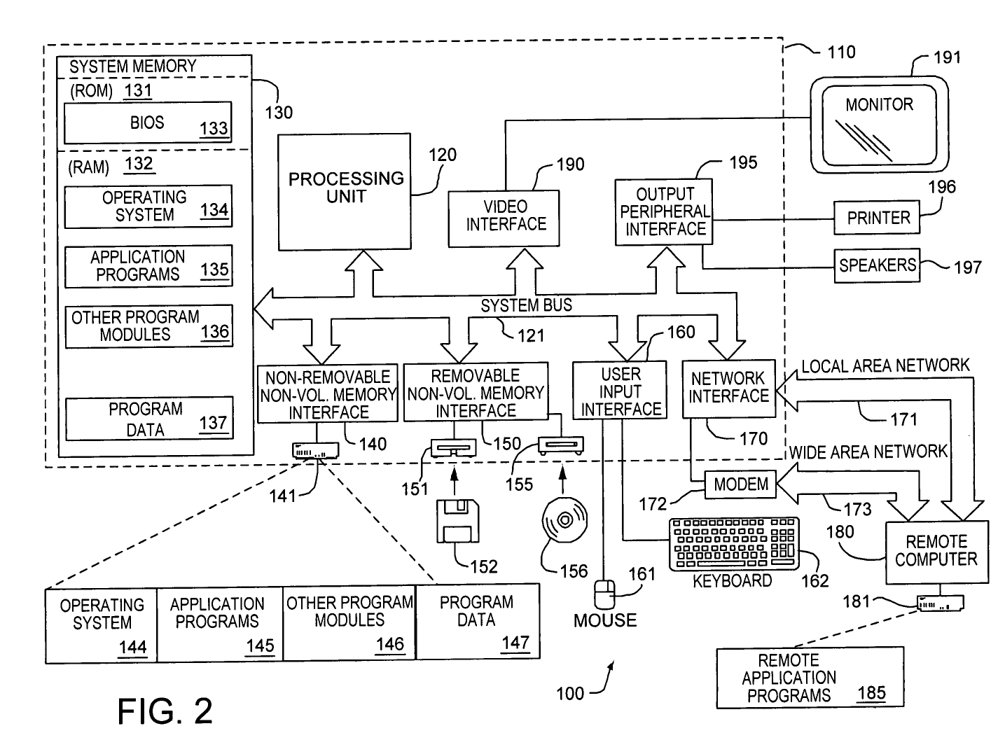

FIG. 2 illustrates an example of a suitable computing system environment 100 in which the color management system 10 may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

With reference to FIG. 2, the exemplary system 100 for implementing the invention includes a general purpose-computing device in the form of a computer 110 including a processing unit 120, a system memory 130, and a system bus 121 that couples various system components including the system memory to the processing unit 120.

Computer 110 typically includes a variety of computer readable media. By way of example, and not limitation, computer readable media may comprise computer storage media and communication media. The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/nonremovable, volatile/nonvolatile computer storage media. By way of example only, FIG. 2 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 in the present invention will operate in a networked environment using logical connections to one or more remote computers, such as a remote computer 180. The remote computer 180 may be a personal computer, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

III. System and Method of the Invention

As set forth above, FIG. 1 illustrates a color management system 10 in accordance with an embodiment of the invention. The color management system enables a user to input a combination of colors, such as colors included in a painting or photograph using an image input mechanism 4. The color management system 10 creates a palette 20 for each input image.

Color palettes 20 enables a theme to be built. Each of the color palettes 20 includes a limited set of colors and may be provided as a distinct module in an operating system. Objects such as buildings or window displays may be used to create each palette 20. Using rules provided by colorist theory, such as the word image scale disclosed by Kobayashi, the color management system 10 allows a user to move from a color painting or other type of input image to the corresponding color palette 20. The color picker 40 may include a mechanism for translating the color painting or other input image into a theme. In embodiments of the invention, the theme may be chosen by the end user in a “themes” tab UI. Thus, each color palette 20 is a limited set of colors that may be harmonious and/or complementary. Each image input by a user creates a distinct corresponding color palette 20. By using this color palette 20, a user can create a windows theme 12 using colorist theory provided by the color picker 40 to set the background and UI colors for applications. Each theme 12 uses a palette 20 to specify which of the colors in the palette 20 will go on which items in a user's desktop.

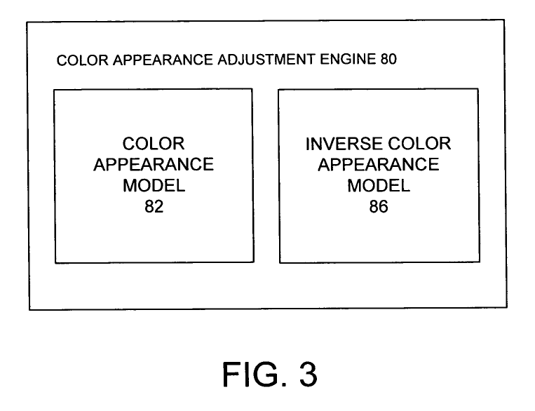

FIG. 3 illustrates further details of the color appearance adjustment engine 80 in accordance with an embodiment of the invention. The color appearance adjustment engine 80 may include a color appearance model 82 and an inverse color appearance model 86. The color appearance model 82 processes colors from an image input through the image input mechanism 4 in order to create a color palette 20 for each image. The color appearance model 82 analyzes the input image to statistically define the color relationships by determining which colors are largest or most prevalent. Based on the statistical definitions, the color appearance model 82 defines a number of distinct colors based on the input image for storage in the corresponding palette 20.

In embodiments of the invention, if the user has a color deficiency, the color appearance model 82 will send its data to the inverse color appearance model 86. The inverse color appearance model 86 transforms the input image colors so that the colors will appear consistent to the color deficient user and incorporates the transformed colors into a palette 20. Current systems merely offer a “high contrast” theme to color deficient users. Such an approach may be inadequate depending on the user's particular color deficiency. For instance, the inverse color appearance model 86 may provide a model that distinguishes red and green more efficiently. In such a model, only selected colors, rather than the entire theme would be high contrast.

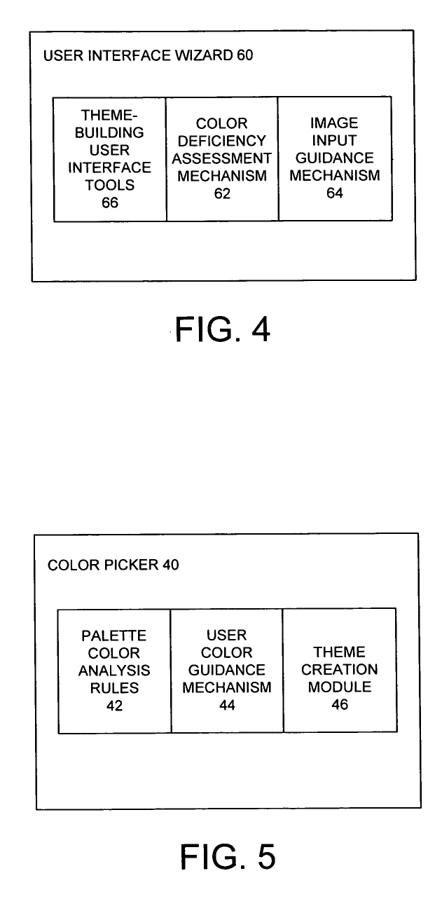

FIG. 4 illustrates an embodiment of the user interface wizard 60. The user interface wizard 60 may be utilized in order to create a theme 12, facilitate image input through the image input mechanism 4, or to inform the color management system of existing user color deficiencies. Accordingly, the user interface wizard may include a color deficiency assessment mechanism 62, an image input assistance mechanism 64, and theme-building user interface tools 66.

The color deficiency assessment mechanism 62 may provide the user with simple tests or questions to assess color deficiency. The color deficiency assessment mechanism 62 may present a dialog that allows a user to select a particular color deficiency prior to completing setup of the color management system 10. Because a limited number of color deficiencies are known, the wizard 60 might present the user with selectable options. Alternatively, the wizard 60 might offer accepted tests to establish color deficiency of a particular user. The information collected from the user through the user interface wizard 60 may be used by the color appearance adjustment engine 80 to create the inverse color appearance model 86. Ultimately, the color deficiency information can be used to improve themes 12 and structured color pickers 40.

The image input assistance mechanism 64 may be provided to assist a user with inputting a photograph through the input mechanism 4. The image input assistance mechanism 64 may include a scanner or camera wizard depending upon the nature of the input mechanism 4.

The theme-building user interface tools 66 may provide a user with selections proposed by the color picker 40 in order to enable the user to build a theme 12. The theme building user interface tools 66 may replicate the input image on the user display and allow the user to point at colors within the image to create a theme based on the input image. Furthermore, the theme building user interface tools 66 may prompt the user to create the theme by offering choices based on colorist theory.

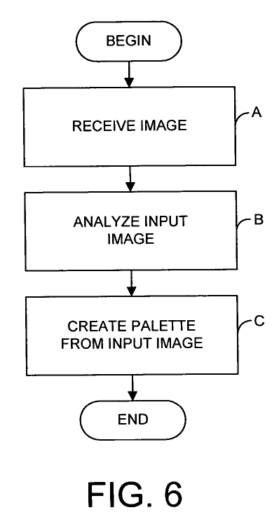

FIG. 5 illustrates a color picker 40 in accordance with an embodiment of the invention. The color picker 40 may include color analysis rules 42, a user color guidance mechanism 44, and a theme creation module 46. The color analysis rules 42 may group and categorize colors contained within the palettes 20 based on colorist theories. For example, colorist theory may be used to pick a selection of colors based on a mood, season, or geographic area input by a user. A word image scale may be implemented that relates words to a spectrum of colors. The user color guidance mechanism 44 may provide a user with color choices based on user preferences and analysis of the colors in the color palettes 20. The color picker 40 may also include a theme creation module 46 for creating a theme-based analysis of palette colors performed by the color analysis rules 42 and the input user preferences.

The color picker 40 may access a number of color spaces such as those provided by the color palettes 20 or may alternatively access a color database such as that provided by the Color Association of the United States (CAUS). Color spaces may also include user selectable spaces such as “Crayola” colors or paint samples. Whereas existing color pickers operate based on a smooth color gradient, the color analysis rules 42 preferably build a structured color picker that complies with a color selection system such as that provided by Kobayashi. The structured color picker 40 implements the color analysis rules to highlight or exposes the “complementary colors” of the extracted color palette 20 or other color space in order to implement the user color guidance mechanism 44.

The color picker 40 may use the same type of process to pick explicit color choices for the user based on a list of colors input by the user. The color picker 40 may extract the palette 20 and bring up choices of colors to pick for a user created theme.

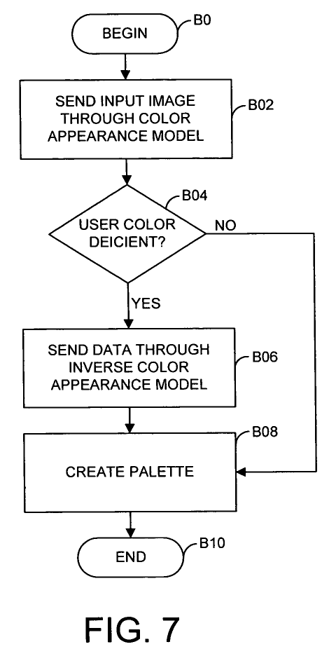

FIG. 6 is a flow chart illustrating creation of a palette in accordance with an embodiment of the invention. In step A, the image input mechanism 4 receives the input image. The color picker 40 may provide a simple UI to allow for selection of the painting or image for acquisition. In step B, the color appearance adjustment engine 80 analyzes colors within the input image. Finally, in step C, the color appearance adjustment engine 80 creates a palette from the input image.

FIG. 7 is a flow chart illustrating the analysis procedure of step B in accordance with an embodiment of the invention. The analysis procedure B demonstrates the incorporation of accessibility support through compensation for color deficiencies. The process begins in step BO and the input is sent through the color appearance model 82 in step BO2. In step BO4, the color appearance adjustment engine 80 determines if a user is color deficient. If the system determines that a user is color deficient in step BO4, the color appearance model sends the data to the inverse color appearance model in step BO6. The color appearance adjustment engine 80 creates a palette 20 for the image in step BO8 and the process ends in step B10. If the user is a color deficient, the created palette 20 may include more distinguishing of specific colors. For instance, if the user's color deficiency pertains to red and green, the color palette 20 may include more distinguishing of red and green.

As described herein, a method and system are provided for automatically extracting a set of colors to create a color palette from a source, such as a photographic image, a painting, or a database. The disclosed system and method allow users more flexibility to set themes that will be appealing. Furthermore, the disclosed method and system compensate for color deficiencies in a seamless manner.

This invention provides a method to integrate a simple wizard to quantify user color deficiency and integrate the results into themes and the structured color picker to optimize the user experience for the color deficient portion of the population. The invention provides novel user experiences to allow users to choose colors and create customized themes and palettes in a simple manner.

While particular embodiments of the invention have been illustrated and described in detail herein, it should be understood that various changes and modifications might be made to the invention without departing from the scope and intent of the invention. The embodiments described herein are intended in all respects to be illustrative rather than restrictive. Alternate embodiments will become apparent to those skilled in the art to which the present invention pertains without departing from its scope.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

What is claimed is:

1. A system for facilitating selection of user interface colors, the system comprising:
at least one color source including multiple selectable colors; and
a structured color picker for selecting color choices from the color source, the structured color picker including a set of colorist theory rules for facilitating selection of harmonious colors from the color source.

2. The system of claim 1, wherein the color source comprises a stored color palette.

3. The system of claim 1, wherein the color source comprises an image input by a user.

4. The system of claim 3, wherein the color source further comprises a palette created from the image input by the user.

5. The system of claim 1, further comprising a user interface wizard for accepting user color selection input.

6. The system of claim 5, wherein the user interface wizard comprises a color deficiency assessment mechanism for assessing user color deficiency.

7. The system of claim 6, further comprising a color appearance adjustment engine, wherein the color appearance adjustment engine receives input from an image input mechanism.

8. The system of claim 7, wherein the color appearance adjustment engine comprises a color appearance model and an inverse color appearance model, wherein the inverse color appearance model compensates for user color deficiencies.

9. The system of claim 5, wherein the user interface wizard further comprises theme building user interface tools.

10. The system of claim 5, wherein the user interface wizard further comprises an image input guidance mechanism that facilitates user creation of the color source.

11. A system for facilitating selection of a user interface theme, the system comprising:
a set of color palettes;
a user interface wizard for allowing a user to select a particular color palette; and
a color picker for selecting harmonious colors from the particular color palette and exposing the harmonious colors to the user through the user interface wizard, wherein the user interface wizard enables the user to construct a theme based on the harmonious colors.

12. The system of claim 11, wherein at least one color palette from the set of color palettes includes colors from an image input by a user.

13. The system of claim 12, further comprising a color appearance adjustment engine, wherein the color appearance adjustment engine receives the image input by the user from an image input mechanism.

14. The system of claim 13, wherein the user interface wizard comprises a color deficiency assessment mechanism for assessing user color deficiency.

15. The system of claim 14, wherein the color appearance adjustment engine comprises a color appearance model and an inverse color appearance model, wherein the inverse color appearance model compensates for user color deficiency.

16. The system of claim 11, wherein the user interface wizard further comprises theme building user interface tools.

17. The system of claim 11, wherein the user interface wizard further comprises an image input guidance mechanism that facilitates user creation of the set of color palettes.

18. A method for facilitating selection of user interface colors, the method comprising:
receiving an input image through an image input mechanism;
processing the input image to replicate input image colors; and
creating a palette based on colors of the input image.

19. The method of claim 18, further comprising accepting user color selection input through a user interface wizard.

20. The method of claim 18 further comprising determining a user color deficiency based information input through a user interface wizard.

21. The method of claim 18, further comprising processing an input image with a color appearance adjustment engine that receives the input from the image input mechanism.

22. The method of claim 21, further comprising processing the input image through a color appearance model and an inverse color appearance model, wherein the inverse color appearance model compensates for user color deficiencies.

23. A computer readable medium storing computer executable instructions for performing the method of claim 18.

24. A method for facilitating selection of user interface colors for a color deficient user, the method comprising:
making a color deficiency determination based on user input;
creating an inverse color appearance model to compensate for the color deficiency; and
processing input colors through the inverse color appearance model prior to presentation to the user.

25. The method of claim 24, further comprising creating a color palette incorporating the colors processed through a color appearance model and the inverse color appearance model.

26. The method of claim 24, further comprising receiving an input source of color from an image input by a user.

27. The method of claim 24, further comprising providing a user interface wizard for accepting user color selection input and user color deficiency input.

28. The method of claim 24, further comprising building a theme that compensates for the determined color deficiency.

29. A computer readable medium storing computer executable instructions for performing the method of claim 24.
